(19) United States
(12) Patent Application Publication
(10) Pub. No.: US 2024/0367148 A1
(43) Pub. Date: Nov. 7, 2024

(54) BIO-GRAFTED SILICA AS AN ADSORBENT OF VOLATILE ORGANIC COMPOUNDS

(71) Applicants: Elham Fini, Phoenix, AZ (US); Saba Shariati, Shenzhen (CN)

(72) Inventors: Elham Fini, Phoenix, AZ (US); Saba Shariati, Shenzhen (CN)

(21) Appl. No.: 18/654,445

(22) Filed: May 3, 2024

Related U.S. Application Data
(60) Provisional application No. 63/499,743, filed on May 3, 2023.

(51) Int. Cl. B01J 20/24; B01J 20/28; C08J 9/00; C08K 9/08; C08L 95/00

(52) U.S. Cl. CPC B01J 20/24; B01J 20/28007; B01J 20/28016; C08J 9/009; C08K 9/08; C08L 95/00; C08J 2375/04; C08K 2201/011

(57) ABSTRACT

A composition includes a multiplicity of particles, a modifier, and a material throughout which the multiplicity of particles is distributed. The multiplicity of particles includes silicate. The modifier includes bio-carbon. The modifier at least partially coats each particle of the multiplicity of particles.

### CROSS-REFERENCE TO RELATED APPLICATION

This application claims the benefit of U.S. Patent Application 63/499,743 filed on May 3, 2023, which is incorporated herein by reference in its entirety.

### STATEMENT OF GOVERNMENT SUPPORT

This invention was made with government support under grant number No. 1935723 awarded by the National Science Foundation. The government has certain rights in the invention.

### TECHNICAL FIELD

This invention relates to methods of making bio-grafted silica modifiers for retaining volatile organic compounds (VOCs) including but not limited to those found in asphalt-surfaced areas, as well as the resulting bio-grafted silica modifiers.

### BACKGROUND

Asphalt is a mixture of a viscous petroleum binder called bitumen and hard, inert materials called aggregates. The composition of bitumen is a complex mixture of low polarity hydrocarbon molecules and relatively higher polarity asphaltene molecules that have dense aromatic cores and polar nitrogen and oxygen atoms. The low polarity hydrocarbon molecules include volatile organic compounds (VOCs) and saturates such as linear, branched, and cyclic saturated hydrocarbons.

Asphalt-surfaced areas such as roads are non-combustion sources of reactive organic compounds in urban areas. The loss of saturate molecules and the emission of other VOCs from bitumen pose a serious threat to the environment. Emission of these compounds from bitumen is exacerbated due at least in part to exposure to sunlight and high temperature, contributing to negative human and environmental health outcomes. Loss of bitumen components over time is linked to the aging of asphalt that reduces service life of roads.

### SUMMARY

This disclosure relates to bio-grafted silica used as an adsorbent of volatile organic compounds (VOCs) including but not limited to those found in bitumen, bio-nano-composites, polymers (e.g., polyurethane foam), wood-polymer composites, plastics, coatings, paints, emulsions, and sealants. Bio-grafted silica made from siliceous material coated with bio-carbon in the form of a liquid, semi solid or solid is used to reduce the emission of environmental pollutants. This disclosure further describes methods of making bio-grafted silica, as well as methods of making the bio-grafted silica modified bitumen. The aromatic components of bio-carbon as well as its polar oxygen-containing functional groups promote the formation of stable bio-grafted silica. The stable bio-grafted silica can be further regenerated using thermal or photo desorption. The bio-grafted silica can be used as a VOC adsorbent independently as a stand-alone composition, or as a component in a mixture. If used in combination with other constituents, bio-grafted silica facilitates intermolecular interactions with select VOCs and increases VOC retention within the constituent matrix. These intermolecular interactions prevent the emissive loss of saturates and VOCs from the constituent matrix.

The bio-grafted silica can act as a sink for the retention of the VOCs, preventing VOC release into the environment. Compared to neat bitumen, bitumen modified with bio-grafted silica nanoparticles resulted in up to 63% greater adsorptive activity, 23% lower chemical aging index, and a 16% reduction in mass loss. The methods of making bitumen modified with bio-carbon grafted silica described herein provide a means to trap volatile organic components of asphalt, simultaneously enhancing air quality and reducing the detrimental effects of bitumen aging, using renewable and environmentally safe bio-carbons.

In a first general aspect, a composition includes a multiplicity of particles including silicate, a modifier including bio-carbon, and a material throughout which the multiplicity of particles is distributed. The modifier at least partially coats each particle of the multiplicity of particles.

Implementations of the first general aspect can include one or more of the following features.

The particles including silicate can include one or more of silica nanoparticles, silica fume, precipitated silica, fly ash, zeolite, bentonite, diatomaceous earth, vermiculite, montmorillonite clay, and bio-silica. The bio-silica can include silica derived from plants (e.g., ash of corn, walnut shell, or rice hull). The silica nanoparticles typically have a diameter in a range of about 5 nm to about 50 nm.

The bio-carbon can include aromatic and polar functional groups. The bio-carbon is derived from one or more of plants, animal biomass, algae, and fungi. One example of animal biomass is swine manure. The bio-carbon can be derived from wood pellets. The bio-carbon includes one or more of 2,6 dimethoxy phenol, 5-tert-butylpyrogallol, furfural, 3-methoxy-1,2-cyclopentanedione, and 2-(4-hydroxy-3,5 dimethoxyphenyl) acetaldehyde. The bio-carbon can be made using thermochemical conversion. The composition forms intermolecular interactions with volatile organic compounds.

The second general aspect is a mixture that includes the composition of the first general aspect. The mixture exhibits reduced emission of volatile organic compounds compared with the mixture without the composition of the first general aspect.

Implementations of the second general aspect can include one or more of the following features.

The mixture can exhibit reduced emission of volatile organic compounds compared with the mixture without the composition of the first general aspect. The material includes one or more of a bio-nano-composite, polymer, wood-polymer composite, plastic, coating, paint, emulsion, and sealant. In some implementations, the polymer includes polyurethane foam. The material can include bitumen.

A third general aspect is an asphalt that includes the composition of the second general aspect. The asphalt exhibits reduced emission of volatile organic compounds compared with asphalt without the composition of the second general aspect.

In a fourth general aspect, making modified bitumen includes combining a modifier including bio-carbon and a multiplicity of particles including silicate to yield bio-grafted silica particles, and combining the bio-grafted silica particles and bitumen to yield the modified bitumen. The modifier at least partially coats each particle of the multiplicity of particles.

Implementations of the fourth general aspect can include one or more of the following features.

The modified bitumen can include about 0.5 wt % to about 5 wt % of the bio-grafted silica particles. The particles including silicate can include silica nanoparticles. The particles including silicate can include one or more of silica nanoparticles, silica fume, precipitated silica, fly ash, zeolite, bentonite, diatomaceous earth, vermiculite, montmorillonite clay, and bio-silica. The silica nanoparticles typically have a diameter in a range of about 5 nm to about 50 nm. The bio-silica includes silica derived from plants. The silica derived from plants can include silica derived from ash of corn, walnut shell, or rice hull.

The bio-carbon can include aromatic and polar functional groups, and can be derived from one or more of plants, animal biomass, algae, and fungi. One example of animal biomass is swine manure. The bio-carbon can be derived from wood pellets. In some cases, bio-carbon includes one or more of 2,6 dimethoxy phenol, 5-tert-butylpyrogallol, furfural, 3-methoxy-1,2-cyclopentanedione, and 2-(4-hydroxy-3,5 dimethoxyphenyl) acetaldehyde. The modified bitumen can be combined with aggregate to yield asphalt.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A depicts adsorption of volatile molecules on pristine silica. FIG. 1B depicts adsorption of volatile molecules on bio-grafted silica.

FIG. 2 is a plot of dynamic vapor sorption isotherm for adsorption of benzofuran to pristine silica and bio-grafted silica.

FIG. 3 is a plot of thermogravimetric analysis of samples listed in Table 4.

### DETAILED DESCRIPTION

This disclosure relates to bio-grafted silica used as an adsorbent of volatile organic compounds (VOCs) including but not limited to those found in bitumen, bio-nano-composites, polymers (e.g., polyurethane foam), wood-polymer composites, plastics, coatings, paints, emulsions, and sealants. Bio-grafted silica made from siliceous material coated with bio-carbon in the form of a liquid, semi solid or solid is used to reduce the emission of environmental pollutants. As used herein, “bio-carbon” generally refers to carbonaceous material derived from biomass. As used herein, “bio-grafted silica” generally refers to siliceous particles including a surface modified with bio-carbon in the form of a liquid, semi liquid, or solid. This disclosure further describes methods of making bio-grafted silica, as well as methods of making bio-grafted silica modified bitumen. The aromatic components of bio-carbon as well as its polar oxygen-containing functional groups promote the formation of stable bio-grafted silica.

Siliceous materials suitable for use as bio-grafted silica include silica nanoparticles (SNPs), silica fume, precipitated silica, fly ash, zeolite, bentonite, diatomaceous earth, vermiculite, montmorillonite clay, and silica sourced from bio-based material (e.g., bio-silica). Sources of bio-silica include plants (e.g., ash of corn, walnut shell, and rice hull).

Reusable adsorbents need to be able to emit captured VOCs at low regeneration temperatures and without degradation, loss of adsorption capacity, or surface fouling. The stable bio-grafted silica can be regenerated using thermal or photo desorption. The bio-grafted silica can be used as a VOC adsorbent independently as a stand-alone composition, or as a component in a mixture. If used in combination with other constituents, bio-grafted silica facilitates intermolecular interactions with select VOCs and increases VOC retention within the constituent matrix. These intermolecular interactions prevent the emissive loss of saturates and VOCs from the constituent matrix. The silica nanoparticles typically have a diameter in a range of about 5 nm to about 50 nm.

The bio-grafted silica SNPs disperse well in bitumen and other matrices such as bio-nanocomposites when compared to neat SNPs. Bio-carbon coating and bio-grafting of silica enhances SNP dispersion. Bio-carbon which coats silica prevents SNPs agglomeration, enhances its dispersion within the matrix and increases its surface area and surface-active sites.

The bio-carbon used to make the modified bitumen composition can include aromatic and polar functional groups. The bio-carbon can be derived from one or more of plants (e.g., wood pellets), animal biomass (e.g., swine manure), algae, and fungi using thermochemical conversion processes. Suitable functional groups in the bio-carbon include phenol, ketone, aldehyde, aryl, polar, hydroxyl, alkoxy, pentose moieties. Sources of the bio-carbon can include lignocellulosic biomass, which includes lignin, cellulose, hemicellulose, and any combination thereof. The bio-carbon can include one or more of 2,6 dimethoxy phenol, 5-tert-butylpyrogallol, furfural, 3-methoxy-1,2-cyclopentanedione, 2-(4-hydroxy-3,5 dimethoxyphenyl) acetaldehyde, and any combination thereof.

Making a modified bitumen composition includes combining a modifier including bio-carbon and a multiplicity of particles including silicate to yield bio-grafted silica particles and combining the bio-grafted silica particles and bitumen to yield the modified bitumen. The modifier at least partially coats each particle of the multiplicity of particles. The method can include combining the modified bitumen composition with aggregate to yield asphalt.

Molecular modeling shows that bio-grafted silica strongly adsorbs organic volatile molecules, acting as a trap for reactive organic volatiles. The efficacy of bio-grafted silica exceeds that of pristine silica. Dynamic vapor sorption analysis confirms that bio-grafted silica outperforms pristine silica to retain a reactive organic compound through an adsorption mechanism. Thermogravimetric analysis shows the effectiveness of the disclosed bio-grafted silica modifier to reduce the mass loss in modified bitumen. Compared to neat bitumen, bitumen modified with bio-grafted SNPs results in up to 63% greater adsorptive activity, 23% lower chemical aging index, and a 16% reduction in mass loss.

### EXAMPLES

Materials. The neat bitumen was grade PG 64-16, acquired from HollyFrontier in Arizona with properties provided in Table 1. The SiO₂ nanoparticles (SNP) were purchased from Sigma-Aldrich (catalog number 718483) with a BET surface area of 175-225 m²/g and an average individual size of 12 nm. Ethanol (ACS grade) was purchased from Fisher Scientific. The bio-carbon was made from wood pellet through thermochemical conversion.

TABLE 1
General properties bitumen binder PG 64-16.

| | |
|---|---|
| Specific Gravity @15.6° C. | 1.025 |
| Flashpoint ° C. | 300 |
| Absolute Viscosity, P | 2.005 |
| G*/sinδ, kPa | 1.23 |
| Mass change after RTFO | −0.210% |
| G*/sinδ, kPa | 3.33 |
| G*sinδ, kPa | 2.87 |
| Stiffness (MPa) @−6° C. @ 60 s | 90.4 |

Surface Modification of SNPs with the Bio-carbon. The surface modification used oil produced from wood pellet. The oil was purified by being dissolved in ethanol (1:3 by weight), sonicated for 3 min at 500 W, and stirred for another 10 min. Then 0.5 g SNP was mixed in 32.5 g ethanol/water (95:5 by weight), followed by 10 min ultrasonication to homogeneously disperse the SNPs. Subsequently, 0.8 g of surface modification solution was added into the SNP system, and the entire system was sonicated again for 5 min. The mixture was next kept at 70° C. under constant stirring for 2 hours. Finally, surface-modified SNPs were separated by centrifugation, washed thoroughly with acetone twice, then washed with water three times. Freeze-drying was used to dry the prepared bio-grafted silica for use in bitumen.

Mixing SNPs with Bitumen. The pristine silica nanoparticles and bio-grafted silica nanoparticles were separately blended with neat bitumen (PG 64-16 graded). Samples were blended at 2% concentration by weight of the bitumen. The mixing temperature was 135° C., and the mixture was hand-blended continuously for 5 min.

Ultraviolet (UV) Aging Method. The unaged samples were exposed to UV radiation to provide accelerated aging. To prepare samples, 3 g of an unaged specimen (neat bitumen, bitumen modified with pristine silica, or bitumen modified with bio-grafted silica) was evenly spread on a silicon rubber pan (75 mm diameter) to make a film 0.65 mm thick. The pan was then placed in a UV chamber 10 cm from a lamp with a UV radiation intensity of 0.71 W/m2. UV exposure continued for 200 hours at 65±1° C. Samples were collected at time intervals of 100 hours and 200 hours.

Dynamic Shear Rheometer. The elastic and viscous properties of each sample (unaged and UV-aged) were measured using an Anton Paar Rheometer MCR 302 following the ASTM standard. Tests were conducted using an 8-mm parallel-plate spindle at a 0.1% strain rate and frequencies ranging from 0.1 to 100 rad/s at 10° C. Throughout the test, stress and strain were measured, and data were used to calculate the shear modulus (G*) and phase angle (8). The complex shear modulus (G*) is a measure of a material's resistance to deformation when repeatedly sheared, and 8 is the time lag between stress and strain. From the data, the modulus and frequency at which the phase angle is 45 degrees were determined as crossover values. At the crossover point, the elastic modulus (G′) and viscous modulus (G″) are equal.

Fourier Transform Infrared (FTIR) Spectroscopy. A Bruker FTIR spectrometer was used to characterize the functional groups of unaged samples and samples subjected to different UV aging levels. Before starting the test, the FTIR diamond crystal surface was cleaned with isopropanol. The background spectrum was collected and subtracted from the sample spectra. FTIR spectra were collected from 400 to 4000 cm⁻¹ wavenumbers with a resolution of 4 cm⁻¹ and 32 scans. To analyze the peaks and calculate the area under each peak, OMNIC software version 9.2.86 was used.

Dynamic Vapor Sorption Method. The adsorption/desorption properties of bio-grafted silica were measured by an automated vacuum vapor/gas gravimetric sorption analyzer manufactured by Surface Measurement Systems Ltd. To perform the test, each sample was exposed to target sorbate (e.g., benzofuran) and the weight of the sample was measured directly using a microbalance with a resolution of 0.1 μg. Measurement was done at a set partial pressure of solvent under vacuum using a mass flow controller. The sorption measurements were done in a mass-equilibrium mode in which the mass-equilibrium criteria were set as a change in mass per minute (dm/dt). The control software automatically calculates and checks the dm/dt criteria against the set dm/dt value. The control software advances the test to the next partial pressure when the sample's mass reaches equilibrium at a selected partial pressure of sorbate molecules.

Thermogravimetric Analysis Method. The mass loss profile was collected on a TA TGA5500 discovery series instrument. A ˜40 mg sample of bitumen was placed on a tared high temperature platinum pan and loaded into the furnace. The temperature was ramped from ambient (˜25° C.) to 100° C. with a ramp rate of 10° C./min. The sample was then subjected to a 48-hour isothermal hold. The sample purge using nitrogen was 25 mL/min and the balance purge using nitrogen was 10 mL/min.

Computation Method. Density functional theory (DFT) was used to characterize the affinity of candidate volatile molecules toward a cluster of pristine silica and a cluster of bio-grafted silica. The bio-grafted silica was modeled as silica grafted with wood-pellet bio-carbon. Non-periodic DFT was used to study all interactions described herein. Calculations were done using the Dmol3 modulus implemented in the Accelrys Materials Studio program package (version 7). The Perdew-Burke-Ernzerhof (PBE) exchange-correlation functional with Grimme's dispersion correction (PBE-D) and all-electron double-numerical polarized basis set (DNP) was applied. Geometry optimizations were performed using the convergence criteria of 2.0×10⁻⁵ hartree, 4.0×10⁻³ hartree/Å, and 5.0×10⁻³ Å for energy, maximum force, and displacement, respectively. Adsorption energies were calculated using Equation 1:

$${E}_{ads} = {E}_{complex} - \sum {E}_{fragment} \qquad ( 1 )$$

where E_{complex} is the total energy of the interacting system, and E_{fragment} is the energy of a fragment within the complex.

Herein, only the uppermost sheet of the silica cluster (including the atoms that can participate in interactions) was optimized; the remaining bottom atoms of the cluster were kept fixed to preserve the bulk-like rigidity.

Molecular Modeling A cluster approach was used to model the silica surface. Using a preliminary periodic boundary condition (PBC) approach, a 3×3×1 Å super cell was built from the unit cell of α-quartz with optimized parameters of a=b=4.928 Å, c=5.428 Å, α=β=90.0°, and γ=120.0°. The silica supercell was then fully optimized at the PBE-D level and with quality of “fine” grid using CASTEP modulus embedded in the Accelrys Materials Studio program package (version 7). A (001) Miller basal plane was cleaved out of the optimized 3×3×1 super cell, dangling bonds were saturated with H and OH end groups, and the periodic condition was removed from the system. The resulting silica cluster model was used for this disclosure.

A silica cluster model with candidate bio-carbon molecules adsorbed on its surface was used as bio-grafted silica. Five molecules of bio-carbon were chosen based at least in part on two criteria: a) their high percent area obtained by gas chromatography mass spectrometry (GC-MS), and b) the variety of functional groups (phenolic OH, ketone, aldehyde, alkoxy) in the molecules' structures. The bio-carbon molecules include 2,6-dimethoxyphenol; 5-tert-butylpyrogallol; furfural; 3-methyl-1,2-cyclopentanedione; 2-(4-hydroxy-3,5 dimethoxyphenyl) acetaldehyde.

Five volatile molecules were selected for this disclosure: Sat1 and Sat2 (two saturate molecules; benzofuran; benzothiophene; benzoic acid. Truncation of the alkane chain was applied to Sat2, in order to obtain a proper size for adsorption of this long-chain alkane molecule on the silica cluster model.

DFT-based calculations. Loss of saturate molecules and release of volatile organic compounds (VOCs) are factors accelerating the aging process of bitumen, contributing to environmental pollution, and endangering the health of living organisms. Recently, the following have been documented as asphalt-related VOCs: chain and cyclic alkanes; aromatic compounds; sulfur-containing molecules such as benzothiophene and dibenzothiophene; and oxygen-containing molecules such as benzofuran and dibenzofuran. Hydrocarbons can be the major contributors to secondary organic aerosols (SOA), followed by sulfur-containing compounds and oxygen-containing compounds as essentially equal contributors. The emission of sulfur-containing volatiles and oxygen-containing volatiles increases with an increase in temperature. Based on this information, the VOCs include C₃₅H₆₂ (Sat1), C₂₀H₄₂ (Sat2), benzofuran, benzothiophene, benzoic acid. The following section reports the intermolecular interactions between candidate VOCs and both pristine silica surfaces and bio-grafted silica surfaces. The potency of both the pristine silica surface and the bio-grafted silica surface to trap the candidate volatile molecules is measured in terms of the adsorption strength of volatile-pristine silica and volatile-(bio-grafted silica).

To model the bio-grafted-silica surface, the candidate molecules of bio-carbon were adsorbed on a silica surface. In the optimized model, multiple hydrogen bonds between the oxygen atoms of bio-carbon molecules and the silanol groups (Si—OH) of the silica surface were observed. In one example, hydrogen bonds were obtained between the adsorbed molecules of bio-carbon. The high binding energy for this adsorption complex (−116.1 kcal/mol) indicates the high thermodynamic stability for adsorption of these bio-carbon molecules on silica. This optimized bio-grafted silica complex was used for the rest of the calculations.

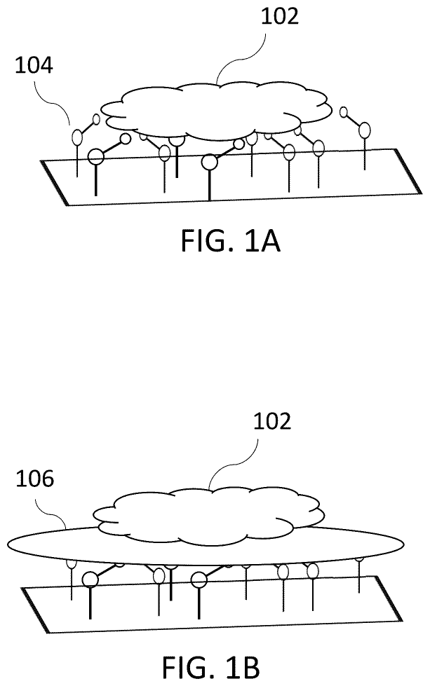

Interaction of volatiles with pristine silica and bio-grafted silica. The adsorption energies for the adsorption of VOCs on a silica cluster and on a bio-grafted silica cluster were calculated considering different orientations for adsorption. A range of adsorption energy was obtained for each adsorption complex; the maximum value is reported here. FIGS. 1A and 1B show schematics for the two kinds of adsorption that are compared in this work. FIG. 1A shows the interaction of volatiles 102 with OH groups 104 of pristine silica. FIG. 1B shows the interaction of volatiles 102 with adsorbed bio-oil 106 bio-grafted silica. The adsorption energies for the adsorption of each volatile to these two systems (silica and bio-grafted silica) are reported in Table 2.

TABLE 2
Adsorption energies (E_{ads}) for the adsorption of volatile molecules
on models of pristine silica and bio-grafted silica

| E_{ads} on silica | E_{ads} on bio-grafted silica |
|---|---|
| (kcal/mol) | (kcal/mol) |
| −54.3 | −70.4 |
| −47.5 | −53.4 |
| −25.2 | −38.3 |
| −19.3 | −31.4 |
| −35.4 | −38.0 |

TABLE 3
Percentage increase in binding energy for the adsorption of
each volatile when shifting from silica to bio-grafted silica

| Volatile | Percentage Increase in binding energy |
|---|---|
| benzoic acid | 7% |
| benzothiophene | 63% |
| benzofuran | 52% |
| Sat1 | 30% |
| Sat2 | 12% |

Table 3 shows the percentage increase in adsorption energy for the adsorption of each volatile when shifting from silica to bio-grafted silica. In one example, DFT results showed that bio-modified silica is capable of trapping the volatiles by providing interactions between bio-grafted silica and volatile molecules. According to these results, bio-grafted silica had better adsorptive performance than pristine silica; this improvement was more pronounced for trapping the sulfur-containing volatiles and the oxygen-containing volatiles in which the S and O atoms are components of an aromatic ring (e.g., benzothiophene and benzofuran).

The effective surface treatment of silica by bio-carbon molecules is indicated by the strong adsorption of bio-carbon to the silica surface and the formation of bio-grafted silica with multiple hydrogen bonds between the two constituents. The involvement of silanol groups in binding with bio-carbon molecules prevents the agglomeration of silica nanoparticles. Agglomeration of silica within the bitumen mixture can affect both the rheological aging index and the chemical aging index of bitumen. Aging in asphalt is also closely related to changes in the colloidal structure of bitumen. Loss of mass is one of the phenomena that disrupts bitumen's colloidal structure and thereby accelerates aging in an asphalt mixture. A decrease in the proportion of saturated aliphatic groups was observed in a sample of aged bitumen. The decrease was indicated by a reduction in the CH₂/CH₃ deformation bands at 1456 and 1375 cm⁻¹ relative to either the 1601 cm⁻¹ peak or the total fingerprint absorption in FTIR spectra. The evaporative loss of small-molecule saturates and aromatics from the bitumen mixture contributes to the aging of bitumen.

The molecular modeling analysis disclosed here showed that bio-grafted silica formed stable complexes with candidate bitumen molecules. Increased intermolecular interactions between the bio-grafted silica modifier and components of bitumen indicate the dispersion of bio-grafted silica within the bitumen medium. The candidate bitumen molecules disclosed here were those recently recognized as components of asphalt emissions. Forming stable adsorption complexes with volatile molecules facilitates the retention of organic volatiles in the asphalt mixture, reducing volatile molecule emission to the environment. In one example, reducing the mass loss can delay aging in bitumen by reducing the deterioration in the rheological properties of bitumen. The affinity of bitumen molecules to form adsorption complexes with bio-grafted silica can also prevent the oxidation of the bitumen molecules and the bitumen molecules' subsequent co-precipitation with other molecules in aged bitumen such as oxidized asphaltenes, reducing the agglomeration and aging in the bitumen complex. The following sections provide evidence from tests showing the reduction in mass loss and the reduction in aging of bitumen modified with bio-grafted silica.

Rheological aging indexes. Exposing bitumen to heat or UV irradiation causes bitumen to age, as evidenced by changes in its physicochemical and rheological properties. In thermal exposure, the dominant mechanism of aging is oxidation; in exposure to UV irradiation, the dominant mechanism of aging is mass loss exacerbated by chain scission. UV aging can be accompanied by a rapid loss of molecules. The loss of aromatics and alkanes reduces the colloidal stability and gives rise to the formation of bitumen agglomerates and an increase in brittleness, which are all recognized as signs of aging. In this disclosure, the crossover frequency (the frequency at which the elastic modulus and the loss modulus are equal) was used to examine the extent of aging in bitumen containing bio-grafted silica. A continuous decrease in the crossover frequency can be an indication of progressive aging.

The aging indices based on the crossover modulus and crossover frequency were computed for samples aged from 0 to 200 hours under UV exposure. From the results, the crossover modulus and crossover frequency showed a sharp decrease after 100 hours of UV aging, and the decrease continued at a slower rate up to 200 hours of UV aging for all samples. These results indicate that most of the effect of UV aging on bitumen occurred within the first 100 hours of UV exposure. The sample of neat bitumen showed a higher value for both crossover modulus and crossover frequency compared to modified samples, but after 200 hours of UV aging, these values were equal to or less than those of the modified samples. This implies that the sample of neat bitumen was susceptible to UV aging. On the other hand, the samples containing pristine silica or bio-grafted silica both showed a lesser reduction in crossover values compared to the sample of neat bitumen over the 200 hours of UV aging. To measure the performance of the pristine silica and bio-grafted-silica in terms of anti-aging properties, the rheological aging index (RAI) was calculated using Eq. 2. A lower value of the rheological aging index indicates better resistance to aging.

$$Rheological Aging Index = \frac{Unaged value - value after 200 hours UV aging}{Unaged value} \qquad ( 2 )$$

where “value” in Eq. 2 is either the crossover modulus or the crossover frequency.

TABLE 4
Rheological aging indices (RAI) based on crossover modulus and
crossover frequency of neat bitumen, bitumen modified with
pristine silica, and bitumen modified with bio-grafted silica

| Sample | Crossover Modulus | Crossover frequency |
|---|---|---|
| Neat Bitumen | 45.1 | 87.3 |
| Bitument modified | 41.0 | 84.5 |
| with pristine silica | | |
| Bitumen modified | 37.7 | 80.7 |
| with bio-grafted silica | | |

Table 4 shows the highest rheological aging index (RAI) was found for the sample of neat bitumen, and the lowest RAI was found for the bitumen modified with bio-grafted silica. A lower value of the RAI indicates better resistance to aging. Bitumen modified with bio-grafted silica showed a lower value of the RAI compared to bitumen modified with pristine silica. This indicates that surface modification of pristine silica with bio-carbon improved the anti-aging properties of silica. The RAI based on the crossover modulus was reduced from 45 for neat bitumen to 38 for bitumen modified with bio-grafted silica, and the RAI based on crossover frequency was reduced from 87 for neat bitumen to 81 for bitumen modified with bio-grafted silica.

To calculate the percentage of improvement in RAI for bitumen modified with pristine silica and bitumen modified with bio-grafted silica, Eq. 3 was used.

$$\% Improvement = \frac{Neat sample RAI - Modified sample RAI}{Neat sample RAI} * 100 \qquad ( 3 )$$

The largest percentage increase was measured for bitumen modified with bio-grafted silica. Bitumen modified with bio-grafted silica showed a 16% increase in the RAI based on the crossover modulus and a 7% increase in the RAI based on crossover frequency, indicating the efficiency of surface modification of pristine silica with bio-carbon. The bitumen modified with pristine silica showed 9% increase in the RAI based on the crossover modulus and a 3% increase in the RAI based on crossover frequency. Bio-carbon and silica nanoparticles can act synergistically to reduce the RAI of bitumen. For example, using crude oil palm treated with nano-silica can notably reduce the RAI of bitumen.

FTIR spectroscopy-based Chemical Aging Index (CAI). FTIR spectroscopy was used to track the extent of change in the chemical structure of bitumen during aging. To quantify the change, Eqs. 4 and 5 were used to calculate the carboxyl functional groups and sulfoxide functional groups of all samples. The Chemical Index was calculated based on Eq. 6. The Chemical Aging Index (CAI) was calculated using Eq. 7. A lower value of the CAI indicates better resistance to aging.

$$Carbonyl Index = \frac{Area under curve from 1680 - 1800 {cm}^{- 1}}{Area under curve from 600 - 4000 {cm}^{- 1}} \times 1000 \qquad ( 4 )$$

$$Sulfoxide Index = \frac{Area under curve from 960 - 1050 {cm}^{- 1}}{Area under curve from 600 - 4000 {cm}^{- 1}} \times 1000 \qquad ( 5 )$$

$$Chemical Index ( CI ) = Carbonyl Index + Sulfoxide Index \qquad ( 6 )$$

$$Chemical Aging Index ( CAI ) = \frac{200 hours UV aged CI - 0 hour UV aged CI}{0 hour UV aged CI} \qquad ( 7 )$$

TABLE 5
Chemical aging index (CAI) of the samples listed in Table 4

| Sample | Chemical aging index |
|---|---|
| Neat Bitumen | 45.1 |
| Bitument modified | 40.4 |
| with pristine silica | |
| Bitumen modified | 34.7 |
| with bio-grafted silica | |

Table 5 shows the chemical aging index (CAI) of the samples listed in Table 4. A lower value of the CAI indicates better resistance to aging. The CAI is largest for the sample of neat bitumen, followed by bitumen modified with pristine silica. Similar to the case for RAI values, the lowest CAI was found for the bitumen modified with bio-grafted silica. The CAI value was reduced from 45 for the sample of neat bitumen to 35 for the bitumen modified with bio-grafted silica. The percentage increase in aging delay for samples modified with pristine silica and bio-grafted silica was calculated using Eq. 8.

$$\% Increase = \frac{Neat sample CAI - Modified sample CAI}{Neat sample CAI} * 100 \qquad ( 8 )$$

The increase in the chemical aging index was largest (23%) for the bitumen modified with bio-grafted silica. The bitumen modified with pristine silica showed a reduced chemical aging index (10.4%) compared to the bitumen modified with bio-grafted silica. The engagement of bitumen molecules in forming stable complexes with bio-grafted silica (as shown by molecular modeling) can reduce the availability of these compounds to oxygen and free radicals and reduce the oxidation of bitumen molecules and the formation of carbonyl and sulfoxide groups in the bitumen mixture. This helps maintain the chemical balance of the bitumen mixture and facilitate its resistance to aging. The chemical interaction between nano-silica and a bio-carbon (crude palm oil) can reduce the effects of aging in a bitumen mixture. The intensity of FTIR peaks related to carboxylic acid or a C—O bond can be reduced, indicating less oxidation in the bitumen modified with nano-silica that had been treated with bio-carbon.

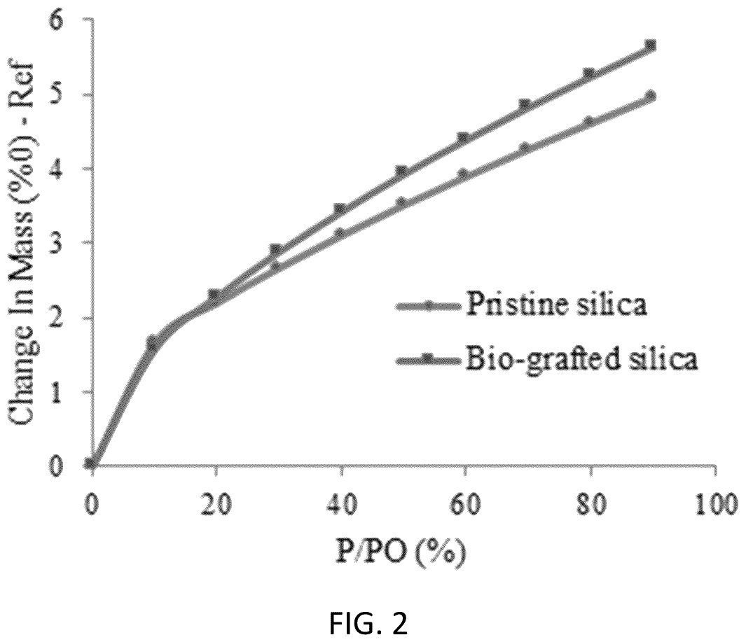

Dynamic vapor sorption analysis. FIG. 2 shows the adsorption kinetics for benzofuran onto treated and untreated silica. As shown in FIG. 2, bio-grafted silica can retain the more adsorbent mass than the pristine silica. Variation in the extent of adsorption indicates that bio-grafted silica could selectively adsorb some potentially hazardous bitumen emissions that would otherwise be emitted from bitumen. This can explain part of the delayed progress of aging observed herein. These results agree with the DFT analysis showing an increase in adsorption energy of benzofuran-(bio-grafted silica) compared to that of benzofuran-silica.

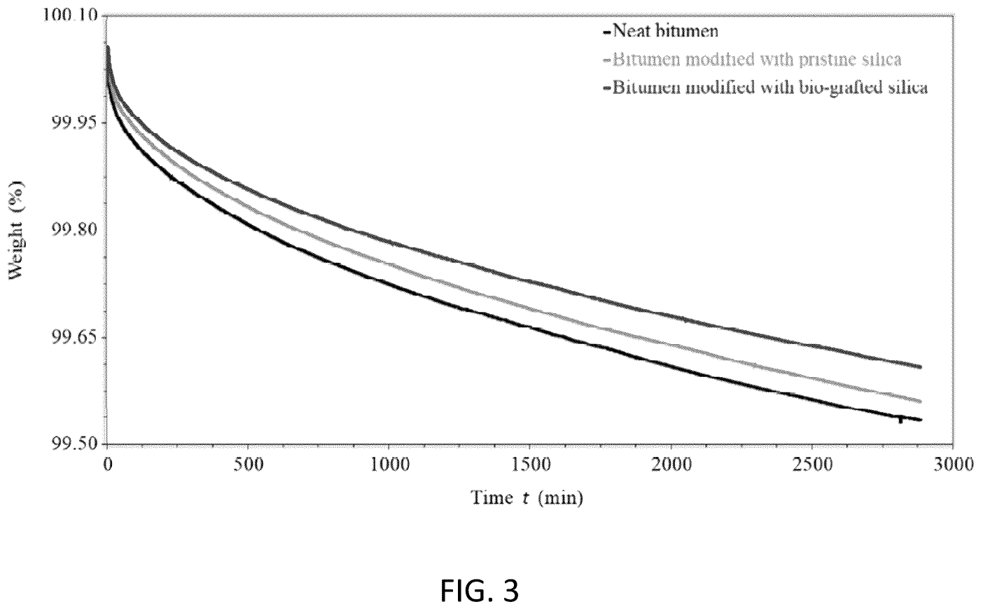

Thermogravimetric analysis. The mass-loss behavior of neat bitumen, bitumen modified with pristine silica, and bitumen modified with bio-grafted silica was examined using thermogravimetric analysis (TGA). FIG. 3 shows the mass loss curves for the three samples during a 48 hours treatment at 100° C. Neat bitumen with a mass loss of 0.467% loses the most mass during the 48 hours test period. Modification of the bitumen with pristine silica led to a 6% reduction in mass loss relative to neat bitumen and a final mass loss of 0.439%. Bitumen modified with bio-grafted silica exhibited the lowest mass loss of 0.392% representing a 16% reduction in mass loss compared to neat bitumen.

Molecular modeling showed that bio-grafted silica strongly adsorbs organic volatile molecules, acting as a trap for reactive organic volatiles. The efficacy of bio-grafted silica is notably higher than that of pristine silica. Dynamic vapor sorption analysis confirmed that bio-grafted silica outperforms pristine silica to retain a reactive organic compound through an adsorption mechanism. Thermogravimetric analysis further proved the effectiveness of the disclosed bio-grafted silica modifier to reduce the mass loss in modified bitumen. Mass loss in bitumen can not only contributes to bitumen's aging but can also make a significant contribution to environmental pollution.

This disclosure shows that even at a low dosage of about 2 wt %, bio-grafted silica combined with bitumen can significantly retain bitumen volatiles. It is expected that a higher concentration could be even more effective, provided that it is properly dispersed within the bitumen matrix. The 2% dosage was selected to avoid any concerns pertaining to the agglomeration of silica. At concentrations above 2%, silica nanoparticles may not properly disperse in bitumen due at least in part to of the agglomeration of silica nanoparticles; agglomeration reduces the surface area and consequently the effectiveness. In one example, selected surface treatments such as salinization can be tailored to ensure proper dispersion.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A composition comprising:
a multiplicity of particles comprising silicate;
a modifier comprising bio-carbon, wherein the modifier at least partially coats each particle of the multiplicity of particles; and
a material throughout which the multiplicity of particles is distributed.

2. The composition of claim 1, wherein the particles comprising silicate comprise one or more of silica nanoparticles, silica fume, precipitated silica, fly ash, zeolite, bentonite, diatomaceous earth, vermiculite, montmorillonite clay, and bio-silica.

3. The composition of claim 2, wherein the bio-silica comprises silica derived from plants.

4. The composition of claim 3, wherein the silica derived from plants comprises silica derived from ash of corn, walnut shell, or rice hull.

5. The composition of claim 2, wherein the silica nanoparticles have a diameter in a range of about 5 nm to about 50 nm.

6. The composition of claim 1, wherein the bio-carbon comprises aromatic and polar functional groups.

7. The composition of claim 1, wherein the bio-carbon is derived from one or more of plants, animal biomass, algae, and fungi.

8. The composition of claim 7, wherein the animal biomass comprises swine manure.

9. The composition of claim 1, wherein the bio-carbon is derived from wood pellets.

10. The composition of claim 1, wherein the bio-carbon comprises one or more of 2,6 dimethoxy phenol, 5-tert-butylpyrogallol, furfural, 3-methoxy-1,2-cyclopentanedione, and 2-(4-hydroxy-3,5 dimethoxyphenyl) acetaldehyde.

11. The composition of claim 1, wherein the bio-carbon is made using thermochemical conversion.

12. The composition of claim 1, wherein the composition forms intermolecular interactions with volatile organic compounds.

13. A mixture comprising the composition of claim 1, wherein the mixture exhibits reduced emission of volatile organic compounds compared with the mixture without the composition of claim 1.

14. The composition of claim 1, wherein the material comprises one or more of a bio-nano-composite, polymer, wood-polymer composite, plastic, coating, paint, emulsion, and sealant.

15. The composition of claim 14, wherein the polymer comprises polyurethane foam.

16. The composition of claim 1, wherein the material comprises bitumen.

17. Asphalt comprising the composition of claim 16, wherein the asphalt exhibits reduced emission of volatile organic compounds compared with asphalt without the composition of claim 16.

18. A method of making modified bitumen, the method comprising:
combining a modifier comprising bio-carbon and a multiplicity of particles comprising silicate to yield bio-grafted silica particles, wherein the modifier at least partially coats each particle of the multiplicity of particles; and
combining the bio-grafted silica particles and bitumen to yield the modified bitumen.

19. The method of claim 18, wherein modified bitumen comprises about 0.5 wt % to about 5 wt % of the bio-grafted silica particles.

20. The method of claim 18, wherein the particles comprising silicate comprise silica nanoparticles.

21. The method of claim 18, wherein the particles comprising silicate comprise one or more of silica nanoparticles, silica fume, precipitated silica, fly ash, zeolite, bentonite, diatomaceous earth, vermiculite, montmorillonite clay, and bio-silica.

22. The method of claim 21, wherein the silica nanoparticles have a diameter in a range of about 5 nm to about 50 nm.

23. The method of claim 21, wherein the bio-silica comprises silica derived from plants.

24. The method of claim 23, wherein the silica derived from plants comprises silica derived from ash of corn, walnut shell, or rice hull.

25. The method of claim 18, wherein the bio-carbon comprises aromatic and polar functional groups.

26. The method of claim 18, wherein the bio-carbon is derived from one or more of plants, animal biomass, algae, and fungi.

27. The method of claim 26, wherein the animal biomass comprises swine manure.

28. The method of claim 18, wherein the bio-carbon is derived from wood pellets.

29. The method of claim 18, wherein the bio-carbon comprises one or more of 2,6 dimethoxy phenol, 5-tert-butylpyrogallol, furfural, 3-methoxy-1,2-cyclopentanedione, and 2-(4-hydroxy-3,5 dimethoxyphenyl) acetaldehyde.

30. The method of claim 18, further comprising combining the modified bitumen with aggregate to yield asphalt.
